(19) United States
(12) Patent Application Publication
(10) Pub. No.: US 2021/0351982 A1
(43) Pub. Date: Nov. 11, 2021

(54) System, Computer Program, Computer-Readable Medium and Method for Automatically Configuring the System

(71) Applicant: Siemens Aktiengesellschaft, Muenchen (DE)

(72) Inventors: Harald ALBRECHT, N?rnberg (DE); Stephan HÖME, Schwabach (DE); Thomas TALANIS, Heroldsbach (DE)

(21) Appl. No.: 17/283,999

(22) PCT Filed: Sep. 18, 2019
(86) PCT No.: PCT/EP2019/074941

§ 371 Date: Apr. 9, 2021

(30) Foreign Application Priority Data
Oct. 12, 2018 (EP) 18200134.7

(51) Int. Cl. H04L 12/24

(52) U.S. Cl. CPC H04L 41/0843; G06F 9/45558; H04L 41/0806; H04L 41/0886

(57) ABSTRACT

A system, in particular an automation system, a computer program, a computer-readable medium and method for automatically configuring the system, wherein when the system is activated and/or during operation of the system, monitoring which physical and/or virtual hardware network interfaces the system comprises is monitored, if a hardware network interface is detected for the first time when the system is activated, or a hardware network interface is newly added during operation of the system, this is communicated to an auto-configuration module of the system, the auto-configuration module creates a configuration description using a template file, and the configuration description is implemented to configure the system in accordance with said description.

### CROSS-REFERENCE TO RELATED APPLICATIONS

This is a U.S. national stage of application No. PCT/EP2019/074941 filed 18 Sep. 2019. Priority is claimed on European Application No. 18200134.7 filed 12 Oct. 2018, the content of which is incorporated herein by reference in its entirety.

### BACKGROUND OF THE INVENTION

### 1. Field of the Invention

The invention relates to a method for automatically configuring a system, in particular an automation system, the system, in particular an automation system, for performing such a method, a computer program and a computer-readable medium.

### 2. Description of the Related Art

Automation systems, in particular for industrial automation installations, such as programmable logic controllers, or industrial PCs, normally have one or more network interfaces, which can be either physical hardware network interfaces or virtual hardware network interfaces, for example, a virtual machine. Various systems from the field of automation engineering can already be equipped with different network interfaces of this kind in the factory, and it is also possible for users to later change the expansion of physical and/or virtual hardware network interfaces, for example, to add or remove one or more such interfaces.

The interfaces are connected to various networks during operation. By way of example, such an interface can be connected to a factory or company network of an operator, one or more interfaces on subordinate machine or cell networks and one or more interfaces on wireless (local area) networks, etc.

When a change to the hardware expansion of interfaces is made, users wish to produce or obtain continuous connectivity between the various networks, for example, a company or production network, subordinate cell or machine networks and a wireless network, as quickly and easily as possible (specifically in accordance with their selected or performed or changed hardware expansion of interfaces) both on initial startup and in the course of operation.

The network connectivity should firstly be integrated as seamlessly as possible into the concerns of industrial production sites but at the same time should also blend in with company IT, for example, with IPv6 routers, which can also be of autoconfiguring design, as provided for in EP 2 940 972 A1 and EP 3 091 714 A1, for example, and/or with NAT64 routers, which can be of adaptive design, as provided for in EP 3 062 490 A1, for example.

In the field of general IT, “container technology”, such as “Docker” or “rkt” (pronounced “rocket”) or “Kubernetes”, has proven its worth (see or EP 3 267 351 A1).

Application containers are usually “encapsulated” units that can be executed independently of one another, regardless of where they are situated. Similarly to in the case of virtual machines, containers are a type of receptacle for applications in which the latter can run. While virtual machines depict an entire computer environment, however, the containers normally just contain the important data needed for executing the respective application or applications.

The container technologies, or containerization, particularly allow software or an application to be packaged in a container that comprises everything that the software or application needs in order to run, such as program code, runtime, system tools and/or system libraries.

The container technologies, or containerization, allow functions to be easily and conveniently packaged in a modular manner, transported and finally rolled out in the operational area. Conventional fields of use for containers are for example convenient packaging of applications, for example, a database or a web front end.

A container is usually generated (instantiated) by a container image, in the case of Docker, for example, a Docker image, which serves as data template.

The applicant is of the opinion that container virtualization has great potential in the field of automation engineering too. For example, in the field of automation engineering, it is conceivable to provide or use (virtual) network functions, in particular for obtaining connectivity, for example in the event of changes to the hardware expansion, and/or other network functions in a containerized manner.

So that such containers having (virtual) network functions are or become ready for use in the first place, they need to be “connected up” or “wired up” to connected networks, or interfaces connected to the networks, however.

The applicant knows that virtual machines (VMs) and containers can be connected up using software switches, which are also called “virtual” switches. Such software switches are, for example, part of the Linux kernel and can be added, changed and also deleted again at any time in the course of operation, which requires not inconsiderable IT or network know-how, however. Such virtual switches can arise, for example, in the case of Linux, explicitly in the form of so-called “kernel bridges”. However, they can, for example, also implicitly be part of a virtual network between a hardware network interface (the so-called master interfaces) and other virtual Macvlan network interfaces.

Docker technology is additionally familiar with “Docker network drivers” with the “container network model”. However, these Docker network drivers require a user to provide a topological description of the required networks and the interconnection thereof, which likewise requires not inconsiderable IT or network know-how and entails not insignificant effort.

Building on Docker network drivers, there is also the technology “Docker Compose”. This is a tool for describing applications that in particular consist of multiple docker containers, including the “network wiring” thereof. However, Docker Compose can merely reference one or more networks that have previously been defined, or created, and configured by means of Docker Driver. In the case of a bridge, for example, the bridge is created; for a Macvlan, it is recorded that this network has been defined, but no specific network elements are created yet. That means that in the case of Macvlan the wiring does not occur until later, whereas for a bridge the parts that are needed independently of the individual container are created already.

The applicant is of the opinion that, when containerizing (virtual) network functions, importance lies not only in incorporating the network functions into the external, physical network but also in correctly wiring up the containers to one another and to the network outside world.

The applicant knows that such wiring would hitherto be implementable in the field of automation characterized by modular hardware by plugging suitable functional modules into a physical hardware controller, such as an S7-1500 from Siemens AG. Here, a user also needs to take action and have appropriate know-how, and additional hardware is necessary.

### SUMMARY OF THE INVENTION

It is therefore an object of the present invention to provide a way for containers having (virtual) network functions to be wired up to one another and to external, physical networks in an automated manner for, and without effort from, the user.

This and other objects and advantages are achieved in accordance with the invention by a method for automatically configuring a system, in particular an automation system, in which startup of the system and/or ongoing operation of the system involve(s) monitoring being performed to ascertain what physical and/or virtual hardware network interfaces the system has. Ifa physical or virtual hardware network interface is detected for the first time on startup of the system, and/or a physical or virtual hardware network interface appears or disappears during operation of the system, then this is communicated to an autoconfiguration module of the system together with information about the type of the affected hardware network interface and/or the type of a network connected or needing to be connected to said hardware network interface.

The autoconfiguration module uses a template file, which is preferably stored on the system and associated with the type of the at least one affected hardware network interface and/or with the type of a network connected or needing to be connected to said hardware network interface, to produce for at least one of the affected hardware network interfaces a container configuration description that comprises a first partial configuration description for at least one communication container, which comprises at least one application via which network functions can be provided, and a second partial configuration description for network functions for connecting the at least one communication container to the at least one affected hardware network interface, in particular in the form of a configuration description for at least one virtual network, such as Macvlan, and/or at least one virtual bridge and/or at least one virtual switch.

In addition, the container configuration description is executed in order to configure the system in accordance therewith, where the at least one communication container is generated and connected to the at least one affected hardware interface.

It is also an object of the invention to provide a system for performing the method in accordance with the invention. Such a system is preferably configured such that autoconfiguration module of the system is sent a report if a physical or virtual hardware network interface is detected for the first time on startup of the system, and/or a physical or virtual hardware network interface appears or disappears during operation of the system, wherein information about the type of the affected hardware network interface and/or the type of a network connected or needing to be connected to said hardware network interface is communicated together with such a report.

The system is additionally configured such that the autoconfiguration module uses a template file, which is stored on the system and associated with the type of the or the respective affected hardware network interface and/or with the type of a network connected or needing to be connected to said hardware network interface, to produce for at least one of the affected hardware network interfaces a container configuration description that comprises a first partial configuration description for at least one communication container, which comprises at least one application via which network functions can be provided for the or the respective affected interface, and a second partial configuration description for network functions for connecting the at least one communication container to the or the respective affected interface, in particular in the form of a configuration description for at least one virtual network, such as Macvlan, and/or at least one virtual bridge and/or at least one virtual switch.

In addition, the system is configured such that the container configuration description is executed in order to configure the system in accordance therewith, where the at least one communication container is generated and connected to the at least one affected hardware interface.

In other words, the present invention closes the “gap” between industrial users and container technology, such as Docker. As such, it becomes possible to render the great advantages of this technology usable for network functions without the user needing specific IT or network or container know-how. The central idea in this case is to use an autoconfiguration module to dynamically and automatically connect containers having network functions, which are also referred to as network function containers or communication containers, in the present case, to their physical network outside world, for which purpose one or more template files are used.

The autoconfiguration module used in accordance with the invention ascertains and monitors the hardware system expansion and therefore the system configuration with reference to the available hardware network interfaces. Hardware network interfaces can be present both in the form of physical hardware network interfaces and in the form of virtual hardware network interfaces. A hardware network interface as defined by the present application is in particular one for which there is provision for at least one driver, in particular at least one operating system driver.

Naturally, it may be that a hardware network interface is added and/or removed many times over the operating period of a system and/or that multiple hardware network interfaces are detected for the first time on startup of a system. Here, preferably many times, possibly even every time, when a network interface is detected for the first time on startup of the system, and/or every time when a physical or virtual hardware network interface appears or disappears during operation of the system, this is communicated to the autoconfiguration module of the system together with information about the type of the respective affected hardware network interface and/or the type of a network connected or needing to be connected thereto, and many times, possibly even every time, such a report results in a template file, which is preferably stored on the system and associated with the type of the respective affected hardware network interface and/or with the type of a network connected or needing to be connected to said hardware network interface, being used to produce and implement, or execute, a container configuration description. The system according to the invention is preferably designed and/or configured for this purpose.

Besides the information about a change with regard to the interfaces having taken place, or an interface being detected for the first time on startup, the autoconfiguration module also obtains information about the type of the interface. In particular, the role that is anticipated for the interface or the type of interface is communicated. This allows, for example, the role “upstream” or “enterprise network” instead of the sometimes varying network interface names such as for example “ens42p66”. This role, or this type, may be called for in a template, for example, explicitly instead of an interface name (such a template may state “role: . . .” instead of “device: . . .”, for example).

The autoconfiguration module then preferably uses a template file associated with the type of the interface, and uses the template file to produce a container configuration description associated with the type of the affected interface. As such, dynamic, context-dependent configuration of the system can occur.

The container configuration description with the partial configuration descriptions thereof is executed, or implemented, subsequently to production thereof, and the at least one communication container is generated and connected to the at least one affected hardware interface. As an alternative to the expression configuration description, the expression configuration instruction could also be used.

Execution or implementation means in particular, or includes in particular, the container configuration description, or parts thereof, being processed by at least one suitable instance, which can be implemented on the system. It may be that the first part of one instance and the second part of another instance is executed, in particular processed. A container configuration description can exist, for example, in the form of a text file, or a text document, that comprises in particular instructions or commands that can be executed, in particular processed, by one or more suitable instances.

The container configuration description comprises at least two partial configuration descriptions.

Specifically, a first that concerns the desired, or necessary, communication container(s). This first partial configuration description is produced for the purpose of further processing in a container system, such as Docker Compose and/or Kubernetes. In other words, a first partial configuration description is preferably produced that is designed or suitable for (subsequently) being processed by a container system, such as Docker Compose and/or Kubernetes. The first partial configuration description is in particular designed, or suitable, for using such a tool to generate at least one communication container therefrom, or on the basis thereof. The first partial configuration can in particular comprise at least one reference, or at least one link, to at least one container, or a container image. There may also be just an image name of at least one communication container contained in the first partial configuration description. The respective operating system configuration can then complete the image name(s) with the location (for example, the URL) of one or more “image registries” as soon as the container image needs to be loaded onto the system, so that one or more containers from the image are or can be shown. A reference can be present in the form of a path statement or URL statement, for example.

The first partial configuration description can be executed, if Docker Compose is used as instance for the execution thereof, in particular by the command “docker-compose <first partial configuration description>”.

If Kubernetes is used as instance for executing the first partial configuration description, then there can be provision, for example, for a “kubelet” on the system on which the container is supposed to be started to itself start a (main) CNI plugin and transfer the first partial configuration description thereto for execution. In particular, in this case, the first partial configuration description is preferably present in the form of, or comprises, one or more so-called Kubernetes resources. These are (small) text documents that each independently describe one or more parts of the container and network configuration and are executed by the Kubernetes mechanisms. Kubernetes resources can be executed, or processed, by applicable controllers, or plugins, such as the cited CNI plugins (for example Multus CNI plugins). The main CNI plugin can be provided by Multus, for example. It can, for example, use its own configuration and the partial configuration description as a basis for deciding what other CNI plugins need to be called, possibly in order, such as the “bridge” CNI plugin or the “macvlan” CNI plugin. Here, the main CNI plugin supervises the forwarding of the necessary parts from the partial configuration description to the CNI plugins that are to be called.

The second partial configuration description describes the necessary virtual network functions, such as virtual, in particular software, (Ethernet) bridges, that are necessary for connecting the communication container(s) to the, or the respective, affected interface. The second partial configuration description concerns in particular virtual network infrastructure of an operating system of the system, or is used for setting up such network infrastructure. As an alternative or in addition to virtual, in particular software, (Ethernet) bridges, it is also possible for virtual “cables”, or virtual Ethernet systems, to be involved, in particular so-called VETHs, or VETH devices, and/or Macvlans (also written MACVLAN or MAC VLAN), which can preferably be virtual cables through to a physical hardware network interface.

VETHs stands for Virtual Ethernet Devices, as are already sufficiently well known from Linux, for example. VETHs usually occur in pairs and act as a virtual piece of cable, as it were, between precisely two VETH network interfaces. They connect in particular a virtual bridge to a container, but can equally also connect two containers directly to one another. In regard to VETHs, see, for example, the Linux manual.

The second partial configuration description expediently concerns network functions at the level of the data link layer (layer 2), in particular at least one virtual network on layer 2, that is to say at least one virtual layer 2 network.

There may also be a requirement, or provision, for wiring of communication containers to one another, and this can accordingly be taken into consideration in the partial configuration description. It is likewise possible for such wiring to be obtained using the aforementioned means, for example, soft bridges and/or virtual cables or the like.

On the basis of the second partial configuration description, the autoconfiguration module ensures in particular that at least one (virtual) internal network, for example, at least one software switch forming an internal network, or at least one software bridge, is linked solely to the affected interface rather than to the host IP stack, as is customary for Docker, in particular. It is also possible to connect the communication container(s) directly to a (“master”, or external) IP interface instead of an (explicit) software bridge, or an (explicit) software switch. The IP interface then secretly undertakes, or “acts out”, the bridge function.

The configuration description can, or is supposed to, be used in particular to produce IP connectivity for the affected interface.

The execution, or implementation, of the container configuration description expediently includes the at least one communication container being generated and in particular connected to the affected network interface for which the container configuration description was produced. The execution, or implementation, of the container configuration description can also include the at least one communication container being started.

In a particularly preferred embodiment, the container configuration description is obtained, or produced, by virtue of one or more wildcards provided in the template file being replaced with at least one parameter associated with the (respective) affected hardware network interface, in particular a name thereof. Preferably, the autoconfiguration module is configured accordingly. Replacing one or more wildcards in the template file with an interface parameter, in particular interface name, is preferably the only action that is performed to obtain a container configuration description from the template file associated with the affected interface. That is, the template file preferably already provides the necessary container configuration description, which still needs to have the context added, however, in particular the information of the specifically affected interface, i.e., the information regarding which physical or virtual interface was detected for the first time, or added.

Replacing wildcards can be performed very easily and allows a (common) template to be used for any number of network interfaces so long as they are distinguished by the same type, or so long as the same role is anticipated for them.

The information about what type of interface the (respective) affected interface is, or what role is anticipated for it, can preferably be communicated to the autoconfiguration module by virtue of at least one parameter associated with the (respective) affected interface being transmitted to said autoconfiguration module, particularly preferably a or the name associated with the (respective) affected interface. Specific name rules are then preferably used for denoting the interfaces. For example, all interfaces of the same type, or having the same role, for example, all upstream interfaces, i.e., interfaces that are connected or need to be connected to an upstream network, are given names, for example, that begin with the same initial character, for example initial letter, for example, all with “ens*”, where “*” means that there follow further characters by means of which the interface is distinguishable from other interfaces.

From the template file, the autoconfiguration module creates, or, if an interface disappears, removes again, in particular for the respective affected interface, i.e., depending on the context, the networks between the respective affected interface and the communication container(s) in a (single) context.

It should be noted that it may be necessary, but does not have to be necessary, for at least one communication container to be set up, or obtained, for each virtual and/or physical hardware network interface of a system that is detected for the first time on startup of the system, or appears during operation of the system.

If at least one virtual and/or physical hardware network interface for which this is not necessary, or desired, is detected for the first time on startup of the system, or appears during operation of the system, then there can be provision for the autoconfiguration module to produce for tha hardware network interface a configuration description that concerns no communication container(s). This type of configuration description, which is referred to as network configuration description in the present case to distinguish it from container configuration descriptions that concern at least one container, concerns in particular only network functions for the, or the respective, affected interface.

In a further embodiment, the autoconfiguration module produces, for at least one further instance of the affected hardware network interfaces, a network configuration description that concerns at least one virtual network and/or at least one virtual bridge and/or at least one virtual switch for the at least one further hardware network interface and no communication container therefor. The system in accordance with the disclosed embodiments of the invention, in particular the autoconfiguration module of the system, is configured accordingly in an advantageous embodiment.

The, or the respective, network configuration description particularly concerns at least one virtual network that needs to be connected, or is connected, to the (respective) affected network interface. In other words, the, or the respective, network configuration description concerns in particular an “internal network”, or an “internal wiring”, for the respective interface, via which the latter can be, or is, connected for example to internal networks, or containers, of other interfaces.

The, or the respective, network configuration description is (totally analogously to the container configuration description(s)) expediently subsequently executed in order to configure the system in accordance therewith.

The network configuration description can (likewise by analogy with the container configuration description) exist, for example, in the form of a text file, or a text document, which comprises in particular instructions, or commands, that can be executed, in particular processed, by one or more suitable instances. In terms of its structure, it can be similar or identical to the container configuration description, in particular the second partial configuration description thereof. The preferred features outlined above in connection with the container configuration description can exist individually or in combination for the network configuration description too, the only difference being in particular that the latter is not used for generating containers.

The, or the respective, network configuration description is, among other things, preferably—likewise totally analogously to the container configuration description(s)—produced by the autoconfiguration module using a template file. Alternatively or additionally, the, or the respective, network configuration description is preferably used for processing in a container system, or container tool, such as for example Docker Compose. It is in particular designed to be executed by such a system.

It should be noted that it is possible for the autoconfiguration module to produce network configuration descriptions for multiple, possibly even all, network interfaces for which no container configuration descriptions are produced. This is not necessary, however. Configuration descriptions for interfaces can also be obtained in another way, in principle.

Although the autoconfiguration module can be used for all network interfaces of a system that are detected for the first time on startup, or appear or disappear during operation of the system, it does not have to be. The approach in accordance with the embodiments of the invention can instead also be used in combination with the conventional, previously known approach, in particular in combination with (partly) manual configuration, for example, by a user. As such, there can be provision for at least one configuration description to be, or to have been, produced for at least one interface in another way, such as manually, as an alternative or in addition to the autoconfiguration module being used for said interface.

It should also be understood there can be provision for conventional, in particular (partly) manual, configuration for any necessary other aspects not covered by the autoconfiguration module, both additionally for interfaces for which the autoconfiguration module is working, or has already worked, and for interfaces for which this is not the case.

In particular, if the autoconfiguration module is used only for one or only for some hardware network interface(s) detected on startup, or appearing later, then a respective (network) configuration description concerning at least one virtual network, such as Macvlan, and/or at least one virtual bridge and/or at least one virtual switch for the latter can be, or may have been, produced for at least one, preferably all, of the remaining network interfaces.

In a preferred embodiment, all necessary “internal wiring” not covered by the autoconfiguration module is obtained in a conventional, previously known manner, in particular by means of manual configuration.

The autoconfiguration module can be implemented as software. The software can then run, e.g., on general hardware of the system that is available for other purposes anyway, as a result of which no additional, or specific, hardware expansion is necessary for implementing the present invention. Naturally, however, it is also possible for there to be provision for specific, additional hardware for the autoconfiguration module (possibly in addition to software thereof). The autoconfiguration module can also be purely hardware implemented.

The system can be, for example, an industrial PC or in particular a programmable logic controller. The system can be part of an industrial automation installation. In principle, the autoconfiguration in accordance with the disclosed embodiments of the invention can be provided for any type of system from the industrial field, in particular industrial automation, whose basic equipment, on startup, comprises one or more (physical and/or virtual) hardware network interfaces and/or to which and/or from which one or more hardware network interfaces are added and/or removed during operation.

The approach in accordance with the disclosed embodiments of the invention affords multiple great advantages. First, industrial users do not need to have specialist IT knowledge to use containerized network functions, for example, either about containers, such as Docker containers, or about associated tools, such as Docker network drivers, or about software switches, and can still use the advantages of this technology for automatic configuration in the event of a change, or addition, to the hardware interface expansion of their systems, or for startup thereof. It therefore becomes particularly simple for users to extend systems from the field of automation engineering by network accesses or feeders, or to remove the like. Manual configuration via additional engineering or configuration tool(s) is no longer required. It suffices to plug in the appropriate network interface hardware, which is then followed by completely automatic configuration.

In a particularly preferred embodiment, the template file is selected from a plurality of different template files, which are in particular stored on the system. A plurality here is intended to be understood to mean two, three, four or more template files. The selection from a plurality of template files is preferably made in an automated manner based on filter rules contained in the template files. The system in accordance with the disclosed embodiments of the invention, in particular the autoconfiguration module of the system, is preferably configured accordingly.

If multiple template files from which it is possible to select are available, then it is a particularly simple matter to react to a first-time detection and/or the new addition of interfaces of different type.

If filter rules are used, then these can concern, for example, one of the names associated with the or the respective affected interface and/or the type of the or the respective affected interface. Interfaces usually have an assigned, or are usually assigned a, unique name, in particular from, or via, the operating system, and the name provides a simple way of distinguishing between different types of interfaces. By way of example, there can be provision for the respective first character, for example letter, of network interfaces of the same type, or having the same role, to match and for the specific individualization to take place using subsequent characters, for example letters.

Additionally preferably, there is provision for in each case at least one, preferably precisely one, template file to be stored, in particular on the system, for multiple types, preferably for each type, of physical and/or virtual hardware network interface that the system can have, and/or for in each case at least one, preferably precisely one, template file to be stored, in particular on the system, for at least three different types of physical and/or virtual hardware network interfaces, the three different types of physical and/or virtual hardware network interfaces particularly preferably being upstream interfaces, which in particular need to be connected or are connected to an upstream network, for example, company network, of a user, downstream interfaces, which need to be connected or are connected to a lower-level network, in particular cell or production network, and WLAN interfaces, which need to be connected or are connected to a wireless network.

The following three types of interfaces are often possible in an industrial setting:
Upstream/infrastructure network interfaces:
These are in particular wired interfaces that usually connect lower-level network segments, for example, fieldbus network segments, such as to an IT infrastructure, for example, a company network.
Wireless network interfaces:
These interfaces provide, usually in automated fashion, local WLAN accesses in particular exclusively to the lower-level fieldbus network segments. This allows, for example, mobile Android and/or iOS devices to also be used in wired automation networks.
Downstream network interfaces:
These interfaces usually lead into lower-level fieldbus network segments, used, for example, for communication between field devices and a controller, or an industrial PC, of an automation installation, to which individual machines, units and automation devices, in particular of an industrial automation installation, are connected as appropriate. Preferably, network functions of Nat64 routers and/or IPv6 routers and in particular commissioning tools such as the Primary Setup Tool (PST), for example, for IP-based field devices, are automatically provided in these “downstream” network segments as soon as a network interface of this type is detected and starts operating.

If template files for obtaining an associated container configuration description are available for these three types of interfaces, or these three roles of interfaces, most cases of interface changes or interface detections in the industrial field can be covered.

In a further preferred embodiment, the detection of a physical or virtual hardware network interface for the first time, on startup of the system and/or the appearance and/or disappearance of a physical or virtual hardware network interface during operation of the system, is communicated to the autoconfiguration module by virtue of an operating system that runs on the system reporting an applicable event to the autoconfiguration module, in particular as a plug-and-play event. In this way, the autoconfiguration module can easily be informed about the hardware interface expansion, or changes thereto. The system in accordance with the disclosed embodiments of the invention is configured accordingly.

As far as the execution, or implementation, of the configuration description and the obtainment of an applicable configuration of the system are concerned, there can be provision for the execution, or implementation, of the first partial configuration description to involve the at least one communication container being generated. The system in accordance with the disclosed embodiments of the invention is preferably configured accordingly. The execution, or implementation, of the first partial configuration description can be effected via a container controller module of the system.

The container controller module is particularly preferably implemented as software, but can, just like the autoconfiguration module, in principle also comprise specific, additional hardware, or else be purely hardware implemented.

The design of a container controller module will usually depend on what container technology or what container technologies are used. The container controller module can comprise or be provided by a Docker Composer tool and/or a Kubernetes Pod Scheduler Controller, for example. . . . If other, or further, container technology/technologies are used as an alternative or in addition to Docker and/or Kubernetes, then the container controller module can expediently comprise, or be provided by, tools associated with this or these technology/technologies that can be used to generate containers from an associated container configuration description.

In a further advantageous embodiment of the method in accordance with the invention, the second partial configuration description is implemented by a network controller module of the system. The system in accordance with the disclosed embodiments of the invention is preferably configured accordingly. The second partial configuration description can be present in the form of a shell script, for example, and/or formed as “systemd units”, and/or as cluster system objects (in particular Kubernetes API objects) and/or the like. . . . The network controller module, which is preferably implemented as software, can then accordingly comprise or be formed by a shell script interpreter and/or systemd and/or a Kubernetes controller.

A communication container is preferably a container whose software content provides network, in particular network communication, functions, particularly preferably on ISO/OSI layers 2 and/or 3 and/or 4 and/or 7. Purely by way of illustration, the implementation of IP traffic between protocol versions 4 and 6 will be cited for a communication container. The software contained in the container preferably provides a dedicated control plane (in this context, reference will be made purely by way of illustration to EP 3 062 490 A1 from Siemens AG) and a data plane (in this context, reference will be made purely by way of illustration to WrapSix NAT64 data plane in user space; Tayga NAT64 in user space). Alternatively, it is also possible for a communication container to implement only a dedicated control plane, while the data plane used is the data plane of the operating system core, as in the case of an autoconfiguring IPv6 router, for example, as disclosed in the earlier European patent application 18192748.4 from Siemens AG.

Particularly preferably, there is additionally provision for at least one application of the at least one communication container, according to the first partial configuration description, to provide functions of an, in particular automatically configuring, IPv6 and/or NAT64 router and/or of a name service, in particular DNS, server and/or of a brouter and/or to be provided by, or to comprise, software for a WLAN access point.

Network functions of the at least one communication container, i.e., network functions according to the first partial configuration description, are in particular those that ensure, or produce, connectivity of the affected hardware network interface to at least one further hardware network interface, or an external network, possibly with network isolation.

Network functions of the at least one communication container can be the following, for example:
autoconfiguring IPv6 routers, preferably along with an autoconfiguring and/or “autoiterative” DNS server, as described in the European patent applications with file reference Nos 18187459.5 and 18187456.1 as well as 17194062.0, which are likewise attributable to the applicant.
autoconfiguring NAT64 routers, in particular including Profinet system scanners as described in EP 3 062 490 B1, which is likewise attributable to the applicant.

Specifically which network functions are provided or need to be provided via the one or more communication containers will be dependent on the type of the affected interface. As already noted above, in particular IPv6 and/or NAT64 functions are usually desired, or necessary, for downstream network interfaces. If a wireless network interface is added, necessary or associated software can be provided in a containerized manner.

In addition to network functions that provide or ensure IP connectivity, in particular, it is possible for further functions, or services, to be provided via one or more containers, for example, commissioning tools, such as the Primary Setup Tool (PST). Such tools can be used to automatically commission, e.g., (IP-based) subscribers of a (partial) network connected to the affected network interface, for example, (IP-based) field devices connected to a fieldbus segment. The first partial configuration description can accordingly also contain details relating to at least one container that comprises at least one application via which, besides network functions, other, or further, functions, or services, can be provided, in particular commissioning functions or services.

Particularly preferably, there can additionally be provision that if a physical or virtual hardware network interface disappears during operation of the system, for example, because it is removed and/or deactivated by a user, associated network functions are deactivated and/or removed and/or communication containers are stopped. This is preferably prompted by the autoconfiguration module. Associated network functions are in particular those that were set up for the affected hardware network interface and that, particularly preferably, were used to ensure connectivity of the affected hardware network interface to at least one further hardware network interface, or to an external network, possibly with network isolation. The system in accordance with the disclosed embodiments of the invention is preferably configured accordingly.

The network functions and/or communication containers that are deactivated and/or removed, or stopped, are particularly preferably those network functions, or communication containers, that appear, according to the invention, in the event of the detection of a hardware network interface for the first time and/or the addition of a hardware network interface when using a template file.

For this purpose, the template file to be used, which is dependent on the type of the network interface that has disappeared, can contain, for example, deletion and/or stop instructions, in particular deletion instructions in reference to network functions for connecting at least one communication container to the affected hardware network interface that has disappeared, for example, in the form of at least one virtual bridge, and/or at least one virtual switch for this connection. The system in accordance with the disclosed embodiments of the invention is preferably configured accordingly.

The template file used in the event of the disappearance of a hardware network interface is particularly preferably the same template file used in the event of a first-time detection and/or the addition of a hardware interface of the same type, or having the same role. Here, deletion and/or stop instructions are preferably additionally contained in the template file. It should be noted that in particular stop instructions concerning communication containers, which need to be interpreted by a container tool, for example, can also be transmitted separately from the template file, such as on a direct or indirect path from the autoconfiguration module to a container control module.

If the same template file is used for the first-time detection, or for the appearance of interfaces, as in the event of the disappearance of interfaces of the same type, then there is preferably provision for precisely one template file, in particular stored on the system, for each interface type, or interface role, which is a particularly “slender” solution for autoconfiguration and automatic deletion.

It is a further object of the present invention to provide a computer program comprising program code means for performing the method in accordance with the disclosed embodiments of the invention.

It is an additional object of the invention to provide a computer-readable medium comprising program instructions which, when executed by a processor on at least one computer, prompt the at least one computer to perform the steps of the method in accordance with the disclosed embodiments of the invention. A computer can be part of a system in accordance with the disclosed embodiments of the invention.

The computer-readable medium can be a CD-ROM or DVD or a USB or flash memory, for example. It will be noted that a computer-readable medium is not intended to be understood to mean exclusively a physical medium but rather can also be present, for example, in the form of a data stream and/or a signal that represents a data stream.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the present invention will become clear from the description of an embodiment of the method and of the system of the present invention that follows with reference to the accompanying drawings, in which:

FIG. 1 shows a purely schematic depiction of a system in accordance with the invention; and

FIG. 2 is a flowchart of the method in accordance with the invention.

### DETAILED DESCRIPTION OF THE EXEMPLARY EMBODIMENTS

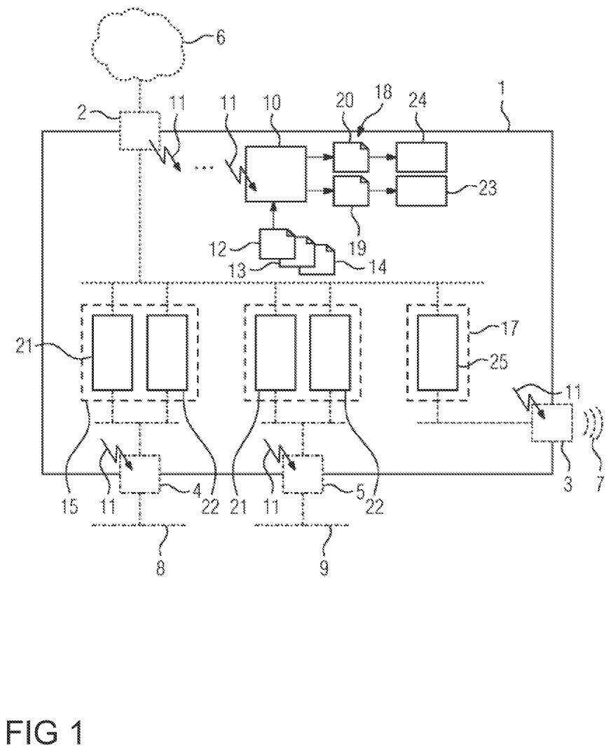

Shown in FIG. 1 is a purely schematic depiction of an exemplary embodiment of an automation system 1 in accordance with the invention for an industrial automation installation, which is not depicted further in the figures.

The automation system 1 in the present case is a programmable logic controller (PLC). It will be stressed that it may alternatively be a different type of system. The autoconfiguration in accordance with the invention can be provided, in principle, for any type of system from the industrial field, in particular industrial automation, whose basic equipment, on startup, comprises one or more hardware network interfaces and/or to which and/or from which one or more hardware network interfaces are (can be) added and/or removed during operation.

The system 1 in the present case has four hardware network interfaces 2, 3, 4, 5. All four interfaces in the illustrated exemplary embodiment are physical hardware network interfaces 2, 3, 4, 5. Alternatively, one, more or all of these interfaces can be virtual hardware network interfaces, such as of one or more virtual machines (VMs).

For each of the four interfaces 2, 3, 4, 5, an operating system of the automation system 1, which is not depicted in FIG. 1, comprises at least one respective driver.

The interfaces 2, 3, 4, 5 are connected to various networks 6, 7, 8, 9.

Specifically, the interface 2, which is an upstream/infrastructure network interface, is connected to a company or factory network 6, which is indicated purely schematically in FIG. 1 by a cloud. The interface 3 is connected to a wireless (local area) network 7 and is therefore a wireless network interface, and the two interfaces 4, 5 are each connected to a lower-level machine or cell network 8, 9. The interfaces 4, 5 in the present case connect lower-level fieldbus network segments to the company network 6. They are downstream network interfaces.

For the purposes of better distinction, FIG. 1 depicts the three different network types and associated elements using different line types, specifically the company network 6 and associated elements using dotted lines, the wireless network 7 and associated elements using dashed lines and the lower-level machine or cell networks 8 and associated elements using dot-dashed lines.

From the point of view of the user, it is worthwhile or desirable for continuous connectivity between the company and production network 6, the lower-level cell or machine networks 8, 9 and the wireless network 7 to be produced as quickly as possible, specifically in accordance with the hardware expansion of interfaces 2, 3, 4, 5 that is performed and/or changed by the user.

To ensure this, the system 1 is configured to monitor, both on startup and during ongoing operation, what physical and/or virtual hardware network interfaces 2, 3, 4, 5 are present. The monitoring is effected in the present case via an operating system installed on the system 1.

The system 1 additionally comprises an autoconfiguration module 10.

If a physical or virtual hardware network interface 2, 3, 4, 5 is detected for the first time on startup of the system 1, or a physical or virtual hardware network interface 2, 3, 4, 5 appears or disappears during ongoing operation of the system 1, then this is communicated to the autoconfiguration module 10, specifically together with information about the type of the affected hardware network interface 2, 3, 4, 5 and/or the type of a network 6, 7, 8, 9 connected or needing to be connected thereto. The communication is effected in the present case by virtue of the operating system reporting an applicable event to the autoconfiguration module 10 as a plug and play event. The report comprises the information concerning what type of event is involved, i.e., whether an interface was detected for the first time or has appeared or disappeared. Additionally, the autoconfiguration module 10 is notified of a name of the respective affected interface 2, 3, 4, 5. The interface names are chosen such that it is possible to derive therefrom what type of interface 2, 3, 4, 5 is involved, or what role is anticipated therefor. If necessary, further information besides the interface name can also be added, for example, the bus connection (in particular hardware connection to the PCI bus or USB bus), or MAC addresses.

Such a hardware or interface event, i.e., the first-time detection or the appearance or disappearance of an interface 2, 3, 4, 5, is indicated purely schematically in FIG. 1 in each case by a lightning flash provided with the reference numeral 11.

Preferably, each time a report of such a hardware event 11 is received by the autoconfiguration module 10, the latter reacts thereto by selecting a template file 12, 13, 14 for the respective context 15, 16, 17 from a plurality of template files 12, 13, 14 stored on the system.

In the present case, three template files 12, 13, 14 are stored in the system, one for each interface type or role, i.e., a template file 12 for a hardware event 11 that concerns a downstream interface 4, 5, a template file 13 for a hardware event 11 that concerns a wireless network interface 3, and a template file 14 for a hardware event 11 that concerns an upstream interface 2. It goes without saying that further template files can be stored for further interface types, or interface roles. Preferably, at least one, in particular precisely one, template file 12, 13, 14 can be stored on the system 1 for each type, or each role, of interface 2, 3, 4, 5 that can occur on a given system 1, which means that every possible hardware expansion, or every possible change thereto, is covered.

The selection of a template file 12 from the plurality of template files 12, 13, 14 for the respective context 15, 16, 17 by the autoconfiguration module 10 is effected based on filter rules stored in the template files 12, 13, 14. Here, the filter rules concern names that are assigned to the interfaces 2, 3, 4, 5 and that are, or were, communicated to the autoconfiguration module 10 for a hardware event 11.

The sequence is described below by way of illustration for the upstream interface 2 and the downstream interface 4, which are newly added by a user. The sequence can be similar if other interfaces 3, 5 are also affected or if they disappear or are detected for the first time on startup.

In reaction to the detection of the interface 2, the autoconfiguration module 10 selects the associated template file 14, i.e., the template file 14 that is provided for such a hardware event 11, specifically for upstream interfaces.

The template file 14 for the interface 2 is selected in this case based on the name of the interface 2, which in the present case is “eth0”; it will be stressed that this is intended to be understood purely by way of illustration. Here, the upstream interface 2 is or was provided with this name deliberately.

The selected template file 14 for the upstream interface 2 reads as follows:

```
match:
  device: “eth0”
networks:
  - {{device.name}}:
    script:
      add:
      - docker network create -d bridge
        1uplink
      - DSBR=‘docker network inspect -format
        ‘{{.Id|printf “br-%.12s”}}’
        1uplink'
      - ip link set {{device.name}} master $DSBR
        remove:
        - Docker network rm 1uplink
```

this being intended to be understood purely by way of illustration, and a template file 14 for an upstream interface 2 also being able to be read differently.

With respect to the three indents under “add:” in the template file 14 cited by way of illustration, which are each preceded by a bullet dash, the following applies: the first indent is used to create an internal network for the interface 2, the second indent is used to ascertain the actual device name of the virtual bridge that was previously created as part of the network (in the example cited, a Linux device name, which is not intended to be understood as restrictive), and the third indent is used to connect the network interface 2 to the virtual bridge.

The indent under “remove:” can be used to remove the internal network for the interface 2 again. This command would take effect, or takes effect, if the interface 2 should disappear, or disappears, again.

As can be seen, the upstream interface 2 is assigned no communication container for the purposes of the exemplary embodiment described, here. No containers are necessary for this role (“upstream”) in the present case, this being intended to be understood purely by way of illustration. It should be understood it is also possible, in principle, for at least one upstream interface 2 to be alternatively assigned at least one container.

The following will be cited as a further example of a template file 14:

```
match:
  device: “eth0”
networks:
- {{device.name}}:
  script:
    add:
    - docker network create -d macvlan
      -o parent={{device.name}}
      1uplink
    remove:
    - Docker network rm 1uplink
```

As can be seen, the second example is one for Macvlan. The line “-o parent={{device.name}}” can be used to notify the instance used for execution or processing, in particular Docker, that containers in this network later need to be coupled to the network interface eth0 by means of Macvlan.

From the template file 14 (according to the first or second example), the autoconfiguration module 10 produces a network configuration description 18 for the interface 2, namely:

#!/bin/bash docker network create -d bridge\1uplink DSBR=‘docker network inspect -format\‘{{.Id|printf “br-%.12s”}}’\1uplink’ip link set eth0 master $DSBR

By using the second example of a template file 14, the following network configuration description 18 is produced:

#!/bin/bash docker network create -d macvlan -o parent=eth0 \1uplink

This allows the network of Macvlan type to be announced to the instance used for execution or processing, in particular Docker. In particular no virtual network components, for example in the Linux kernel, are created yet. It is merely remarked that eth0 will need to be used to connect by Macvlan.

The network configuration description 18 is produced from the template file 14 by virtue of the autoconfiguration module 10 replacing the wildcard {{device.name}}, which occurs repeatedly in the template file 14, with specific values, in the present case the specific interface name ens33p0.

It will be noted that FIG. 1 shows two partial configuration descriptions 19, 20 besides the network configuration description 18. These two are present for the case in which the configuration description produced concerns one or more communication containers 21, 22 (container configuration description 18), as is the case for the interface 4 and described in detail later on. As far as the interface 2 is concerned, it can be assumed as a simplification that the network configuration description 18 is formed only by the upper part 20.

The network configuration description 18 (or 20) is implemented, or executed, in order to configure the system 1 in accordance therewith.

The system 1 has a container controller module 23 and a network controller module 24, which are both software implemented in the present case.

In the presently described example, the network controller module 24 is used for implementing, or executing, the network configuration description 18 (or 20) for the interface 2. It is present because the network configuration description 18 for the interface 2 is provided in the form of a shell script, specifically formed as a shell script interpreter, or comprises a shell script interpreter. It should be understood that the network controller module 24, if the network configuration description 18 is generated in another form, can also be formed differently, for example, as a systemd or Kubernetes controller, or can comprise these.

The execution of the network configuration description 18 by the network controller module 24 creates a virtual bridge and connects the interface 2 to this virtual bridge. This virtual bridge can later be used to connect, for example, communication containers 21, 22 that are assigned to other interfaces 4.

With respect to the downstream interface 4 that appears during ongoing operation, the following applies for the purposes of the presently described exemplary embodiment:

In reaction to the new addition of the interface 4, in particular by a user, the autoconfiguration module selects the template file 12, i.e., the template file 12 that is provided for such a hardware event 11, specifically for downstream interfaces.

The selection in this case is made on the basis of the name of the added interface, which in the present case is “ens33p2”, or on the basis of an in particular first part of the name “ens*”; it will be stressed that this is intended to be understood purely by way of illustration. Here, downstream interfaces that are used for connecting fieldbus network segments are deliberately provided with a name that begins with the three letters “ens”.

The selected template file 12 for the interface 4 has the following appearance in the present case; it will be stressed that this is a purely illustrative version, and template files for downstream interfaces 4, 5 can also have a different form:

```
match:
  device: “ens*”
networks:
  - {{device.name}}:
    script:
      add:
      - ip link add br{{device.name}} type bridge
      - ip link set br{{device.name}} up
      - ip link set {{device.name}} master br{{device.name}}
      - ip link {{device.name}} up
      remove:
      - ip link del br{{device.name}}
containers:
  v6router:
    image: . . .
    networks:
    - uplink
    - {{device.name}}
  anat64:
    image: . . .
    networks:
    - {{device.name}}
```

“match:”, or the first two lines of this file, provides the filter rules concerning the interface name. If a name of an interface 2, 3, 4, 5 that is detected for the first time, newly added or disappears begins with “ens*”, this template file 12 is selected.

The following will be cited as a second example of a template file 12 for a downstream interface 4:

```
match:
  device: “ens*”
networks:
  - {{device.name}}:
    script:
      add:
      - docker network create -d bridge
        2{{device.name}}_downstream
      - DSBR=‘docker network inspect -format
        ‘{{.Id|printf “br-%.12s”}}’
        2{{device.name}}_downstream'
      - ip link set {{device.name}} master $DSBR
      remove:
- Docker network rm 2{{device.name}}_downstream
containers:
  v6router:
    image: . . .
    networks:
    - 1uplink
    - 2{{device.name}}_downstream
  anat64:
    image: . . .
    networks:
    - 2{{device.name}}_downstream
```

The foregoing example is advantageous in particular if an internal network assigned to the network interface 2 has already been created in another way. The template 12 now describes how the bridge network that is still missing for the new interface 4 needs to be created: it is a shell script that creates the network by Docker command and places the new interface 4 under the control of the bridge. In line with the first example, a script is involved and a bridge network is created.

With respect to the three indents, or commands (in each case after a bullet dash), listed in the “add” section, the first creates an internal network with a virtual bridge under the name “2ens33p2_downstream”, the portion “ens33p2” being the name of the network interface 4, the second ascertains the actual device name (Linux device name in the cited example) of the virtual bridge that was created beforehand as part of the network, and the third connects the network interface 4 to the virtual bridge that was created beforehand as part of the network.

The indent that comes next, specifically after “remove:”, removes the network along with the virtual bridge between the container 21 and the interface 4. This indent takes effect if the interface 4 disappears again.

With respect to the two indents after “networks:”, “1uplink” provides the reference to the internal network already created previously on the interface 2, and “2{{device.name}}_downstream” provides the reference to the preceding internal network created for the interface 4.

“-2{{device.name}}_downstream” in the last line of the template 12 is used to connect the container to the internal network for the interface 4. A direct connection to the internal network of the interface 2 is not necessary by way of illustration; instead, this connection is made indirectly via the v6router container.

The following will furthermore be cited as a third example of a template file 12 for a downstream interface 4:

```
match:
  device: “ens*”
networks:
  -{{device.name}}:
    script:
      add:
      - docker network create -d macvlan
        -o parent={{device.name}}
        2{{device.name}}_downstream
      remove:
      - Docker network rm 2{{device.name}}_downstream
containers:
  v6router:
    image: . . .
    networks:
    - 1uplink
    - 2{{device.name}}_downstream
  anat64:
    image: . . .
    networks:
    - 2{{device.name}}_downstream
```

As can be seen, this example is again one for Macvlan.

The autoconfiguration module 10 uses the template file 12 (according to the first or the second or the third cited example) to produce a container configuration description 18 that comprises a first partial configuration description 19 and a second partial configuration description 20.

It should be noted that simplified FIG. 1 schematically depicts the sequence of the production of a configuration description only once for both interfaces 2 and 4 for purposes of increased clarity. The element with the reference sign 18 therefore represents both the network configuration description produced for the interface 2 and the container configuration description produced for the interface 4 with the two partial configuration descriptions 19 and 20.

Here, the first and second partial configuration descriptions 19, 20 of the container configuration description 18 are produced from the template file 12 by virtue of the autoconfiguration module 10 replacing the wildcard {{device.name}}, which occurs repeatedly in the template file 12, with specific values, in the present case the specific interface name, i.e., ens33p2.

The first partial configuration description 19 (and the associated lines 14 to 23 of the template file 12) in the present case concerns two communication containers 21, 22, which each comprise at least one application via which network functions can be provided.

The first partial configuration description 19 of the container configuration description 18 specifically has (on the basis of the first cited example of a template 12) the following appearance, this again being intended to be understood purely by way of illustration:

```
version: “3”
services:
  v6router:
    image: . . .
    networks:
    - 1upstream
    - 2downstream
  anat64:
    image: . . .
    networks:
    - 2downstream
networks:
  1upstream:
    external: upstream
  2downstream:
    external: ens33p2
```

Based on the second above-cited example for a template file 12 for the downstream interface 4, the following is obtained for the first partial configuration description 19:

```
version: “3”
services:
  v6router:
    image: . . .
    networks:
    - 1upstream
    - 2ens33p2_downstream
  anat64:
    image: . . .
    networks:
    - 2ens33p2_downstream
networks:
  1upstream:
    external: true
  2ens33p2_downstream:
    external: true
```

Based on the third example of a template file 12 for the downstream interface 4, the following is obtained for the first partial configuration description 19:

```
version: “3”
services:
  v6router:
    image: . . .
    networks:
    - 1upstream
    - 2ens33p2_downstream
  anat64:
    image: . . .
    networks:
    - 2ens33p2_downstream
networks:
  1upstream:
    external: true
  2ens33p2_downstream:
    external: true
```

As evident, network functions of an IPv6 router and of an NAT64 router are provided in containerized form in the present case—for all three examples.

The respective first partial configuration description 19 is the configuration description for the communication containers 21, 22 desired or required in the respective context 15, 16, 17. It thus concerns the container expansion, which is dependent on the context 15, 16, 17 and dependent on the type, or role, of the affected interface 4. It is used in particular for further processing in a container system, or container tool, such as for example Docker Compose.

The respective second partial configuration description 20 (and the associated lines 3 to 12, or 13, of the respective associated template file 12) concerns network functions for connecting the communication containers 20, 21 to the affected hardware network interface 4 in the form of a configuration description for, in the present case, a virtual bridge at operating system level, or (if an interface 4 is not added, as in the present case, but rather removed) deletion instructions (“remove: . . .”) for an interface. These take effect if the autoconfiguration module 10 has been sent a communication indicating that a downstream interface 4 for connecting fieldbus network segments has disappeared.

The second partial configuration description 20 specifically has (based on the first cited example of the template file 12) the following appearance, which again is intended to be understood purely by way of illustration:

#!/bin/bash

ip link add brens33p2 type bridge

ip link set brens33p2 up

ip link set ens33p2 master brens33p2

ip link ens33p2 up

From the second example cited above for the template file 12, the following is obtained for the second partial configuration description 20:

#!/bin/bash docker network create -d bridge\2ens33p2 downstream DSBR=‘\docker network inspect -format ‘{{.Id|printf “br-%.12s”}}’2ens33p2 downstream’ip link set ens33p2 master $DSBR

As evident, this example of a second partial configuration description 20 is identical in structure to the example of a network configuration description 18 that was described above for the interface 2.

From the third example of the template file 12, the following is obtained for the second partial configuration description 20:

#!/bin/bash docker network create -d macvlan\-o parent=2ens33p2\2ens33p2 downstream

The respective second partial configuration description 20 describes (separately from the configuration description 19 for the container expansion) necessary virtual network functions that are necessary in the respective context 15, 16, 17 for connecting the respective communication containers 21, 22 to the respective interface 4. Here, the generated description is present as a shell script. Alternatively, it can also be formed as “systemd units”, as cluster system objects (Kubernetes), or the like.

On the basis of this description 20, the autoconfiguration module 10 particularly ensures that at least one software switch forming the internal network is linked solely to the interface 4 that has appeared rather than to the host IP stack, as is customary with Docker.

The first partial configuration description 19 and the second partial configuration description 20 (according to the first, second or third example) are implemented, or executed, in order to configure the system 1 in accordance therewith.

The implementation, or execution, of the first partial configuration description 19 concerning the containers 21, 22 is effected via the container controller module 23 and the implementation of the second partial configuration description 20 concerning the operating system level is effected by the network controller module 24.

The container controller module 23 in the present case is software implemented, specifically formed as a Docker Composer tool, or comprises a Docker Composer tool, this being intended to be understood by way of illustration. If, as an alternative or in addition to Docker, such as Kubernetes, is used as container technology, then the container controller module 23 can also be formed as a Kubernetes Pod Scheduler Controller, or can comprise a Kubernetes Pod Scheduler Controller. Other or further container technologies are naturally likewise possible.

It should be noted that, for the purposes of the presently described examples, the second partial configuration description 20 is executed before the first partial configuration description 19, this not being intended to be understood as restrictive. In the case of Kubernetes, for example, the two partial configuration descriptions 19, 20 are “loaded” into the cluster and then automatically executed in the correct order by the cluster mechanisms (such as kubelet and CNI plugins). If Kubernetes is used as instance for executing the first partial configuration description, there can be provision, for example, for a “kubelet” on the system upon which the container(s) 21, 22 is/are supposed to be started to itself start a (main) CNI plugin and transfer the first partial configuration description 19 thereto for execution. The main CNI plugin can be provided by Multus, for example. It can, for example, use its own configuration and the partial configuration description 19 as a basis for deciding what other CNI plugins need to be called, possibly in order, such as the “bridge” CNI plugin or the “macvlan” CNI plugin. Here, the main CNI plugin supervises the forwarding of the necessary parts from the partial configuration description 19 to the CNI plugins that are to be called.

As a result of the execution of the first partial configuration description 19 by the container controller module 23, the communication containers 21, 22 having the IPv6 and NAT64 router functions are generated.

Here, the autoconfiguration module 10 additionally directly or indirectly notifies the container controller module 23 that the communication containers 21, 22 need to be started in the present case, because the interface 4 was added and not removed. If the latter were alternatively the case, the autoconfiguration module 12 would notify the container controller module 23 that the communication containers 21, 22 need to be stopped rather than started.

The network controller module 24 for executing, or implementing, the second partial configuration description 20 is, as already noted above, likewise software implemented and formed as a shell script interpreter, or comprises a shell script interpreter.

It should be noted that the sequence can be totally analogous if, instead of a downstream interface 4, a different type of interface 3, or an interface 3 having a different role, is added. Merely the specific communication container expansion according to the first partial configuration description 19 and the virtual network functions according to the second partial configuration description 20 can or will then differ. If, for example, a wireless network interface 3 is added, the functions of an IPv6 and NAT64 router would not be provided in containerized fashion, but rather, for example, suitable software for a WLAN access point. An appropriate communication container 25 for this context 17 is depicted, likewise purely schematically, in the figure.

It is naturally also possible, as an alternative to the above examples, for the autoconfiguration module 10 to produce a container configuration description 18 for the interface 2 instead of a network configuration description 18 if one or more communication containers 21, 22, 25 are supposed to be provided for the interface 2. The sequence for the interface 2 could then be analogous to that described above for the interface 4.

If an interface needs to be assigned at least one communication container 21, 22, 25 based on its role, then it is possible for a container configuration description 18 to be produced, and if no communication container 21, 22, 25 is necessary or desired, a network configuration description 18.

Additionally, it will be stressed that the autoconfiguration module 10 can, but does not have to, be used for all of the network interfaces 2, 3, 4, 5 of a system 1. The approach in accordance with the invention can naturally also be used in combination with the approach previously known from the prior art. By way of example, as an alternative to the autoconfiguration module 10 producing a network configuration description 18 for the interface 2, as described above, a network configuration description can be, or may have been, produced in a conventional manner, in particular as part of a manual configuration, for example, by a user. The manually obtained network communication description 18 can have, for example, exactly the same appearance as the aforementioned network communication description obtained by the autoconfiguration module 10 using the template file 14.

In a preferred embodiment, at least for those interfaces 3, 4, of a system 1 for which in each case one or more communication containers 21, 22, 25 need to be provided, the autoconfiguration module 10 automatically produces a container configuration description 18 therefor. If an automatic sequence that is as comprehensive as possible is desired, which is usually particularly advantageous, then it is additionally also possible for network configuration descriptions 18 to be produced by the autoconfiguration module 10 for all of the interfaces 2 of a system for which no communication containers 21, 22, 25 are necessary, as described by way of illustration above for the interface 2.

The approach in accordance with the disclosed embodiments of the invention can close the “gap” between industrial users and container technology, such as Docker. As such, it becomes possible to render the great advantages of this technology usable for network functions without the user needing specific IT or network or container know-how. The autoconfiguration module 10 and the template files 12, 13, 14 can be used to dynamically and automatically connect containers having network functions to their physical network outside world, specifically in a manner suited to the respective context 15, 16, 17. Industrial users do not need to have specialist IT knowledge about containers, such as Docker containers, or about associated tools, such as Docker network drivers, or else about software switches, and can still use the advantages of this technology for automatic configuration in the event of a change, or addition, to the hardware interface expansion of their systems, or for startup thereof. It becomes particularly simple for users to extend systems 1 from the field of automation engineering by network accesses or feeders. Manual configuration via additional engineering or configuration tool(s) is no longer required. It suffices to plug in the appropriate network interface hardware, which is then followed by completely automatic configuration.

Although the invention has been illustrated and described more thoroughly in detail by the preferred exemplary embodiment, the invention is not restricted by the disclosed examples, and other variations can be derived therefrom by a person skilled in the art without departing from the scope of protection of the invention.

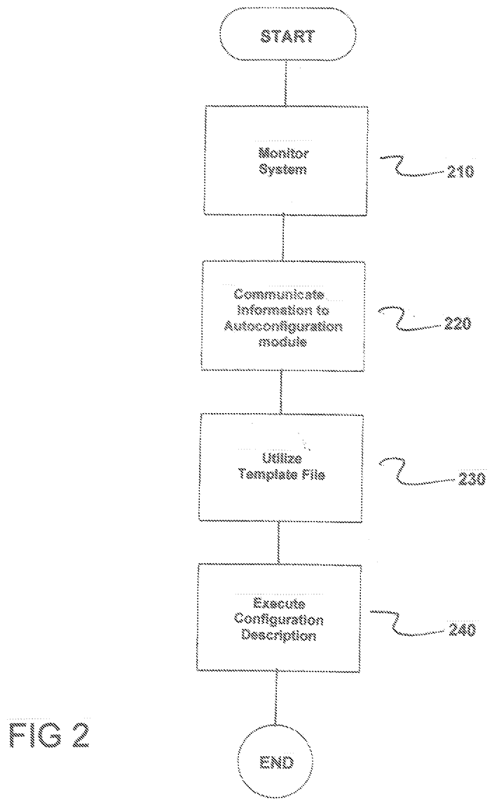

FIG. 2 is a flowchart of the method for automatically configuring a system 1. The method comprises performing, during either startup of the system 1 and/or ongoing operation of the system 1, monitoring of the system to ascertain what physical or virtual hardware network interfaces 2, 3, 4, 5 the system 1 includes, as indicated in step 210.

Next either a type of affected hardware network interface 2, 3, 4, 5 and/or a network 6, 7, 8, 9 connected or needing to be connected to said hardware network interface is communicated to an autoconfiguration module 10 of the system 1 together with information about, if either a physical or virtual hardware network interface 2, 3, 4, 5 is detected for a first time on startup of the system 1 and/or a physical or virtual hardware network interface 2, 3, 4, 5 appears or disappears during operation of the system 1, as indicated in step 220.

Next, the autoconfiguration module 10 utilizes a template file 12, 13, 14 to produce for at least one of the affected hardware network interfaces 2, 3, 4, 5 a configuration description 18 that comprises a first partial configuration description 19 for at least one communication container 21, 22, 25, which comprises at least one application via which network functions can be provided, and a second partial configuration description for network functions for connecting the at least one communication container 21, 22, 25 to the at least one affected hardware network interface 2, 3, 4, 5, as indicated in step 230.

Next, executing the configuration description is executed to configure the system 1 in accordance therewith, the at least one communication container 21, 22, 25 being generated and connected to the at least one affected hardware interface 2, 3, 4, 5, as indicated in step 240.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-24. (canceled)

25. A method for automatically configuring a system, the method comprising:
performing, during at least one of (i) startup of the system and (ii) ongoing operation of the system, monitoring of the system to ascertain what physical or virtual hardware network interfaces the system includes;
communicating to an autoconfiguration module of the system together with information about at least one of (i) a type of affected hardware network interface and (ii) a networkconnected or needing to be connected to said hardware network interface, if at least one of (i) a physical or virtual hardware network interface is detected for a first time on startup of the system and (ii) a physical or virtual hardware network interface appears or disappears during operation of the system;
utilizing, by the autoconfiguration module, a template file to produce for at least one of the affected hardware network interfaces a configuration description which comprises a first partial configuration description for at least one communication container, which comprises at least one application via which network functions can be provided, and a second partial configuration description for network functions for connecting the at least one communication container to the at least one affected hardware network interface; and
executing the configuration description to configure the system in accordance therewith, the at least one communication container being generated and connected to the at least one affected hardware interface.

26. The method as claimed in claim 25, wherein the configuration description is obtained by virtue of at least one wildcard provided in the template file being replaced with at least one parameter associated with the affected hardware network interface.

27. The method as claimed in claim 25, wherein the template file is selected from a plurality of different template files.

28. The method as claimed in claim 26, wherein the template file is selected from a plurality of different template files.

29. The method as claimed in claim 27, wherein the selection is made based on filter rules contained in the template files.

30. The method as claimed in claim 27, wherein at least one of:
(i) at least one template file is stored for multiple types of physical and/or virtual hardware network interface that the system can have, and
(ii) at least one template file is stored in each case for at least three different types of physical and/or virtual hardware network interfaces.

31. The method as claimed in claim 29, wherein at least one of:
(i) at least one template file is stored for multiple types of physical and/or virtual hardware network interface that the system can have, and
(ii) at least one template file is stored in each case for at least three different types of physical and/or virtual hardware network interfaces.

32. The method as claimed in claim 25, wherein at least one of (i) the detection of a physical or virtual hardware network interface for the first time on startup of the system and (ii) the appearance and/or disappearance of a physical or virtual hardware network interface during operation of the system is communicated to the autoconfiguration module by virtue of an operating system that runs on the system reporting an applicable event to the autoconfiguration module.

33. The method as claimed in claim 25, wherein the at least one communication container is generated by a container controller module of the system.

34. The method as claimed in claim 25, wherein at least one of:
(i) the second partial configuration description is executed by a network controller module of the system and
(ii) the first partial configuration description is executed by a container controller module of the system.

35. The method as claimed in claim 25, wherein at least one application of the at least one communication container, in accordance with a first partial configuration description, provides functions of at least one of (i) an IPv6 router, (ii) NAT64 router (iii) a name service client or server and (iv) a brouter and (v) is provided by, or comprises, software for a WLAN access point.

36. The method as claimed in claim 25, wherein the autoconfiguration module prompts at least one of (i) removal, (ii) deactivation of network functions for the affected interface and (ii) stopping of communication containers for the affected interface, if a physical or virtual hardware network interface disappears during operation of the system.

37. The method as claimed in claim 25, wherein the autoconfiguration module produces for at least one further instance of the affected hardware network interfaces a network configuration description which concerns at least one of (i) at least one virtual network and/or at least one virtual bridge and (ii) at least one virtual switch for the at least one further hardware network interface and no communication container therefor.

38. A system comprising
a processor;
memory; and
an autoconfiguration module;
wherein the system is configured to:
send a resort to the autoconfiguration module if at least one of (i) a physical or virtual hardware network interface is detected for the first time on startup of the system and (ii) a physical or virtual hardware network interface appears or disappears during operation of the system, information about a type of at least one of (i) the affected hardware network interface and (ii) a network connected or needing to be connected to said hardware network interface being communicated together with said report;
wherein the autoconfiguration module utilizes a template file to produce for at least one affected hardware network interface a configuration description which comprises a first partial configuration description for at least one communication container, which comprises at least one application via which network functions can be provided for the or the respective affected interface, and a second partial configuration description for network functions for connecting the at least one communication container to the or the respective affected interface; and
wherein the configuration description is executed to configure the system in accordance therewith, where the at least one communication container being generated and connected to the at least one affected hardware interface.

39. The system as claimed in claim 38, wherein the autoconfiguration module is designed to replace at least one wildcard provided in the template file with at least one parameter associated with the or the respective affected hardware network interface to obtain the configuration description.

40. The system as claimed in claim 38, wherein the autoconfiguration module is configured to select the template file from a plurality of different template files.

41. The system as claimed in claim 39, wherein the autoconfiguration module is further configured to select the template file from a plurality of different template files.

42. The system as claimed in claim 40, wherein the autoconfiguration module is further configured to perform the selection based on filter rules contained in the template files.

43. The system as claimed in claim 40, wherein at least one of:
(i) at least one template file is stored in each case on the system for multiple types of physical and/or virtual hardware network interfaces that the system can have and
(ii) at least one template file is stored in each case on the system for at least three different types of physical and/or virtual hardware network interfaces.

44. The system as claimed in claim 42, wherein at least one of:
(i) at least one template file is stored in each case on the system for multiple types of physical and/or virtual hardware network interfaces that the system can have and
(ii) at least one template file is stored in each case on the system for at least three different types of physical and/or virtual hardware network interfaces.

45. The system as claimed in claim 38, wherein the system is further configured to communicate at least one of (i) detection of a physical or virtual hardware network interface for the first time on startup of the system and (ii) one of an appearance and disappearance of a physical or virtual hardware network interface during operation of the system to the autoconfiguration module by virtue of an operating system that runs on the system reporting an applicable event to the autoconfiguration module.

46. The system as claimed in claim 38, further comprising:
a container controller module which is configured to generate the at least one communication container.

47. The system as claimed in claim 38, further comprising at least one of (i) a network controller module which is configured to execute the second partial configuration description and (ii) a container controller module which is configured to execute the first partial configuration description.

48. The system as claimed in claim 38, wherein the system is further configured such that at least one application of the at least one communication container, in accordance with the first partial configuration description, provides functions of at least one of (i) an IPv6 router, (ii) a NAT64 router, (iii) a name service client or server, (iv) a brouter, and (v) is provided by, or comprises, software for a WLAN access point.

49. The system as claimed in claim 38, wherein the system is further configured such that the autoconfiguration module prompts at least one of (i) removal and (ii) deactivation of at least one of network functions and virtual networks for the affected interface, if the autoconfiguration module is sent a report that a physical or virtual hardware network interface disappears during operation of the system.

50. The system as claimed in claim 38, wherein the autoconfiguration module is further configured to produce for at least one further instance of the affected hardware network interfaces a network configuration description that concerns at least one of (i) at least one virtual network, (ii) at least one virtual bridge and (iii) at least one virtual switch for the at least one further hardware network interface and no communication container therefor.

51. A computer program comprising program code instructions for performing the method as claimed in claim 25.

52. A non-transitory computer-readable medium encoded with computer program instructions which, when executed by a processor on at least one computer, cause the at least one computer to automatically configuring a system, the computer program instructions comprising:
program code for performing, during at least one of (i) startup of the system and (ii) ongoing operation of the system, monitoring of the system to ascertain what physical or virtual hardware network interfaces the system includes;
program code for communicating to an autoconfiguration module of the system together with information about at least one of (i) a type of affected hardware network interface and (ii) a network connected or needing to be connected to said hardware network interface, if at least one of (i) a physical or virtual hardware network interface is detected for a first time on startup of the system and (ii) a physical or virtual hardware network interface appears or disappears during operation of the system;
program code for utilizing, by the autoconfiguration module, a template file to produce for at least one of the affected hardware network interfaces a configuration description which comprises a first partial configuration description for at least one communication container, which comprises at least one application via which network functions can be provided, and a second partial configuration description for network functions for connecting the at least one communication container to the at least one affected hardware network interface; and
program code for executing the configuration description to configure the system in accordance therewith, the at least one communication container being generated and connected to the at least one affected hardware interface.
